(19) United States
(12) Patent Application Publication
(10) Pub. No.: US 2026/0258261 A1
(43) Pub. Date: Sep. 3, 2026

(54) HEAT-SENSITIVE RECORDING MATERIAL

(71) Applicant: Oji Holdings Corporation, Tokyo (JP)

(72) Inventors: Shinya AKIMOTO, Tokyo (JP); Shigeo AOYAMA, Tokyo (JP)

(73) Assignee: Oji Holdings Corporation, Tokyo (JP)

(21) Appl. No.: 18/995,621

(22) PCT Filed: Jul. 24, 2023
(86) PCT No.: PCT/JP2023/027024

§ 371 Date: Jan. 16, 2025

(30) Foreign Application Priority Data
Jul. 26, 2022 (JP) 2022-119021
Jul. 26, 2022 (JP) 2022-119022

(51) Int. Cl. C09D 5/26; C09D 7/40; C09D 7/63; C09D 7/65

(52) U.S. Cl. CPC C09D 5/26; C09D 7/63; C09D 7/65; C09D 7/68; C09D 7/70

(57) ABSTRACT

Disclosed is a heat-sensitive recording material comprising a support having at least one colored surface, and a light-scattering layer on the colored surface, wherein the light-scattering layer contains a clarifying agent, the light-scattering layer is substantially free of a dye precursor and a developer, and any one of the following requirements (A) and (B) is satisfied:

(A) the light-scattering layer further contains non-hollow polymer particles, the content of the non-hollow polymer particles is 25 to 60 mass % based on the total solids content of the light-scattering layer, and the content of the clarifying agent is 10 to 40 mass % based on the total solids content of the light-scattering layer; and

(B) the light-scattering layer further contains hollow polymer particles and an inorganic pigment.

### TECHNICAL FIELD

The present invention relates to a heat-sensitive recording material.

### BACKGROUND ART

Heat-sensitive recording materials, which are in wide practical use, record color images by taking advantage of a heat-induced color development reaction between a colorless or pale-colored dye precursor and a phenol or an organic acid. Such heat-sensitive recording materials have advantages in that, for example, color images can be formed simply by the application of heat, and further, recording devices for these can be compact, can be easily maintained, and generate less noise. For this reason, heat-sensitive recording materials have been used in a broad range of technical fields as information-recording materials for printing devices such as label printers, ticket vending machines, CDs, ATMs, order form output devices for use in restaurants etc., data output devices in apparatuses for scientific research, etc.

Examples of heat-sensitive recording materials other than such heat-sensitive recording materials that take advantage of a color development reaction between a dye precursor and a developer include the heat-sensitive recording material reported in PTL 1.

PTL 1 reports a recording material comprising a) a support comprising at least one colored surface and b) a layer arranged thereon, the layer comprising polymer particles having a core/shell structure and 1 wt % to 90 wtg based on the weight of the polymer particles, of an opacity reducer having a melting point of 45° C. to 200° C., wherein the particles have an outer first polymer shell having a calculated Tg of 40° C. to 130° C., and the particles comprise, when dry, at least one void.

In this heat-sensitive recording material, the colored surface is concealed with an opaque layer, and when the opacity reducer is melted by heat, the layer on the colored surface becomes transparent, making the colored surface visible and thus making printing possible.

However, conventional heat-sensitive recording materials that are substantially free of a dye precursor and a developer are insufficient in terms of whiteness, color density, and printability, and have room for improvement.

### CITATION LIST

### Patent Literature

PTL 1: JP2014-512290A

### SUMMARY OF INVENTION

### Technical Problem

A primary object of the present invention is to provide a heat-sensitive recording material that is substantially free of a dye precursor and a developer, and that has excellent whiteness, color density, and printability.

### Solution to Problem

In order to solve the above problem, the present inventors conducted extensive research and found that the above problem can be solved by blending 25 to 60 mass % of non-hollow polymer particles and 10 to 40 mass % of a clarifying agent in a light-scattering layer, and by using at least hollow polymer particles, a clarifying agent, and an inorganic pigment in the light-scattering layer. The present invention has thus been completed. Specifically, the present invention relates to the following heat-sensitive recording material.

### Item 1

A heat-sensitive recording material comprising:
a support having at least one colored surface; and
a light-scattering layer on the colored surface,
wherein
the light-scattering layer contains a clarifying agent,
the light-scattering layer is substantially free of a dye precursor and a developer, and
any one of the following requirements (A) and (B) is satisfied:
(A) the light-scattering layer further contains non-hollow polymer particles, the content of the non-hollow polymer particles is 25 to 60 mass % based on the total solids content of the light-scattering layer, and the content of the clarifying agent is 10 to 40 mass % based on the total solids content of the light-scattering layer; and
(B) the light-scattering layer further contains hollow polymer particles and an inorganic pigment.

### Item 2

The heat-sensitive recording material according to Item 1, which satisfies the requirement (A).

### Item 3

The heat-sensitive recording material according to Item 2, wherein the clarifying agent contains at least one member selected from the group consisting of stearic acid amide, palmitic acid amide, aromatic oxalic acid ester, aromatic ethylene glycol ether, ethylene-bis-stearic acid amide, 1,2-diphenyloxyethane, 1,2-bis(3-methylphenoxy) ethane, dibenzyl oxalate, dibenzyl terephthalate, benzyl-biphenyl, benzyl-2-naphthyl ether, diphenyl sulfone, m-terphenyl, p-benzyloxybenzyl benzoate, cyclohexane dimethanol benzoate, p-toluenesulfonamide, o-toluenesulfonamide, 2,6-diisopropylnaphthalene, 4,4-diisopropylbiphenyl, and erucic acid amide.

### Item 4

The heat-sensitive recording material according to Item 2, wherein the clarifying agent contains at least one member selected from the group consisting of stearic acid amide and palmitic acid amide.

### Item 5

The heat-sensitive recording material according to Item 2, wherein the clarifying agent contains both stearic acid amide and palmitic acid amide.

### Item 6

The heat-sensitive recording material according to any one of Items 2 to 5, wherein the content of the non-hollow polymer particles is 30 to 50 mass % based on the total solids content of the light-scattering layer.

### Item 7

The heat-sensitive recording material according to any one of Items 2 to 6, wherein the content of the clarifying agent is 20 to 35 mass % based on the total solids content of the light-scattering layer.

### Item 8

The heat-sensitive recording material according to any one of Items 2 to 7, wherein the average particle diameter of the non-hollow polymer particles is 0.2 to 3.0 μm.

### Item 9

The heat-sensitive recording material according to any one of Items 2 to 8, wherein the refractive index of the non-hollow polymer particles is 1.55 to 1.65.

### Item 10

The heat-sensitive recording material according to Item 1, which satisfies the requirement (B).

### Item 11

The heat-sensitive recording material according to Item 10, wherein the inorganic pigment comprises an inorganic pigment having an oil absorption of 100 ml/100 g or more.

### Item 12

The heat-sensitive recording material according to Item 10 or 11, wherein the inorganic pigment comprises an inorganic pigment having an average particle diameter of 0.2 to 0.7 μm.

### Item 13

The heat-sensitive recording material according to any one of Items 10 to 12, wherein the content of the inorganic pigment is 10 to 25 mass % based on the total solids content of the light-scattering layer.

### Item 14

The heat-sensitive recording material according to any one of Items 10 to 13, wherein the content of the hollow polymer particles is 6 to 35 mass % based on the total solids content of the light-scattering layer.

### Item 15

The heat-sensitive recording material according to any one of Items 10 to 14,
wherein the content of the clarifying agent is 1 part by mass or more, on a solids basis, per part by mass of the hollow polymer particles, and
wherein the clarifying agent
   A) consists of a fatty acid amide, or
   B) comprises a combination of a fatty acid amide and at least one member selected from the group consisting of a compound represented by the following formula (1) and 1,2-bis(phenoxymethyl)benzene;

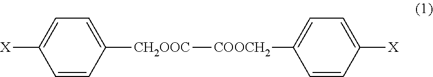

wherein in the formula, Xs are the same or different, and each represents CH₃ or Cl.

### Advantageous Effects of Invention

The heat-sensitive recording material of the present invention is a heat-sensitive recording material that is substantially free of a colorant precursor and a developer, and that has excellent whiteness, color density, and printability. The heat-sensitive recording material according to another embodiment of the present invention is excellent, in particular, in both head residue resistance and head abrasion resistance in terms of printability.

### DESCRIPTION OF EMBODIMENTS

In the present specification, the expression “comprise” or “contain” includes the concepts of comprising, consisting essentially of, and consisting of.

In the present specification, a numerical range indicated by “ . . . to . . . ” means a range including the numerical values given before and after “to” as the lower limit and the upper limit.

“Latex” as used herein includes one in the form of a gel or dry film formed by drying a dispersion medium.

In the present invention, the average particle diameter refers to a median diameter on a volumetric basis as measured by laser diffractometry. More simply, the average particle diameter may also be indicated by the average value of the particle diameter of 10 particles measured from a particle image (SEM image) of an electron microscope.

The present invention provides a heat-sensitive recording material comprising:
a support having at least one colored surface; and
a light-scattering layer on the colored surface,
wherein
the light-scattering layer contains a clarifying agent,
the light-scattering layer is substantially free of a dye precursor and a developer, and
any one of the following requirements (A) and (B) is satisfied:
(A) the light-scattering layer further contains non-hollow polymer particles, the content of the non-hollow polymer particles is 25 to 60 mass % based on the total solids content of the light-scattering layer, and the content of the clarifying agent is 10 to 40 mass % based on the total solids content of the light-scattering layer; and
(B) the light-scattering layer further contains hollow polymer particles and an inorganic pigment.

A heat-sensitive recording material having the feature (A) above is referred to as “heat-sensitive recording material (A),” and a heat-sensitive recording material having the feature (B) above is referred to as “heat-sensitive recording material (B).” These are described in detail below.

### A. Heat-Sensitive Recording Material (A)

In the present invention, the heat-sensitive recording material comprises a support having at least one colored surface and a light-scattering layer on the colored surface, wherein the light-scattering layer contains non-hollow polymer particles and a clarifying agent, the content of the non-hollow polymer particles is 25 to 60 mass& based on the total solids content of the light-scattering layer, the content of the clarifying agent is 10 to 40 mass % based on the total solids content of the light-scattering layer, and the light-scattering layer is substantially free of a dye precursor and a developer.

### Support

The support in the present invention is not particularly limited in type, shape, dimension, or the like. For example, high-quality paper (acid paper, neutral paper), medium-quality paper, coated paper, art paper, cast-coated paper, glassine paper, resin laminate paper, polyolefin-based synthetic paper, synthetic fiber paper, nonwoven fabrics, synthetic resin films, various transparent supports, or the like can be appropriately selected and used. In an embodiment of the present invention, the support may have a colored surface on one surface or may be colored on both surfaces. The color may be imparted, for example, by pigments, dyes, or the inherent color of the support. Alternatively, the support may be immersed in a colorant to provide a colored surface. The thickness of the support is not particularly limited, and is typically about 20 to 200 μm. The density of the support is not particularly limited, and is preferably about 0.60 to 0.85 g/cm³.

### Colored Surface

The heat-sensitive recording material of the present invention has at least one colored surface on the support. Due to the presence of the colored surface, printing is made possible when the light-scattering layer becomes transparent by heat.

The support may have a colored surface on one surface or on both surfaces. The colored surface is not limited as long as it has sufficient color density that is visibly contrasting to the light-scattering layer arranged on the surface. The colored surface may be uniform or varied in color density or may be patterned. The color of the colored surface is also not particularly limited and may be any color.

The colored surface may be a colored layer formed on the support. The colored layer may contain a colorant for imparting color, such as a dye, a pigment, and carbon black. The content of the colorant can be selected from a wide range, and is typically preferably about 5 to 50 mass %, more preferably about 7 to 30 mass %, based on the total solids content of the colored layer.

The colored layer may contain a pigment other than the colorant, Examples of pigments include inorganic pigments, such as calcium carbonate, magnesium carbonate, kaolin, calcined kaolin, clay, talc, calcined clay, silica, diatomaceous earth, synthetic aluminum silicate, zinc oxide, titanium oxide, aluminum hydroxide, barium sulfate, surface-treated calcium carbonate, and silica; hollow polymer particles; non-hollow polymer particles; and the like. The content of the pigment can be selected from a wide range, and is typically preferably about 30 to 80 mass %, and more preferably about 40 to 70 mass %, based on the total solids content of the colored layer.

The colored layer is typically formed by mixing and stirring a colorant, a pigment other than the colorant, a binder, an auxiliary agent, and the like to prepare a coating liquid for a colored layer using water as a medium, and then applying the coating liquid to the support, followed by drying. The coated amount of the coating liquid for a colored layer is not particularly limited, and is preferably about 2 to 15 g/m², and more preferably about 3 to 10 g/m² in terms of dry mass.

Examples of binders include water-soluble polymeric materials, such as polyvinyl alcohol and derivatives thereof, starch and derivatives thereof, cellulose derivatives, such as hydroxymethylcellulose, hydroxyethylcellulose, hydroxypropylcellulose, carboxymethylcellulose, methylcellulose, and ethylcellulose, sodium polyacrylate, polyvinylpyrrolidone, acrylamide-acrylic acid ester copolymers, acrylamide-acrylic acid ester-methacrylic acid ester copolymers, styrene-maleic anhydride copolymers, isobutylene-maleic anhydride copolymers, casein, gelatin, and derivatives thereof; emulsions, such as polyvinyl acetate, polyurethane, polyacrylic acid, polyacrylic acid ester, vinyl chloride-vinyl acetate copolymers, polybutyl methacrylate, and ethylene-vinyl acetate copolymers; latexes of water-insoluble polymers, such as styrene-butadiene copolymers and styrene-butadiene-acrylic copolymers; and the like. The content of the binder can be selected from a wide range, and is typically preferably about 5 to 40 mass %, and more preferably about 10 to 30 mass %, based on the total solids content of the colored layer.

### Light-Scattering Layer

The heat-sensitive recording material of the present invention comprises a light-scattering layer on the colored surface. The light-scattering layer contains non-hollow polymer particles and a clarifying agent. The light-scattering layer is substantially free of a dye precursor and a developer.

### Non-Hollow Polymer Particles

Due to the presence of non-hollow polymer particles, light scattering occurs in the light-scattering layer, making it possible to conceal the colored surface. Furthermore, the use of non-hollow polymer particles achieves excellent color density compared to the use of hollow polymer particles.

Resins that can be used for the non-hollow polymer particles typically include acrylic resins and polystyrene resins. In particular, styrene-acrylic copolymers are preferred.

The average particle diameter of the non-hollow polymer particles in the present invention is preferably 0.1 to 5.0 μm, more preferably 0.2 to 3.0 μm, and even more preferably 0.4 to 2.0 μm. The average particle diameter as used herein is the diameter at which the volume of larger particles is equal to the volume of smaller particles when particles are divided into two kinds based on the particle diameter, i.e., the median diameter, which is the particle diameter corresponding to 50 volume % frequency. The average particle diameter is also referred to as “D50.” The average particle diameter (D50) of the non-hollow polymer particles can be measured using a laser diffraction particle diameter distribution analyzer. The average particle diameter may also be indicated by the average value of the particle diameter of 10 particles measured from a particle image (SEM image) of an electron microscope. An average particle diameter of the non-hollow polymer particles of 0.1 to 5.0 μm can improve whiteness of the heat-sensitive recording material.

The refractive index of the non-hollow polymer particles in the present invention is preferably 1.55 to 1.65, more preferably 1.57 to 1.63, and even more preferably 1.57 to 1.60. The refractive index as used herein can be measured according to, for example, Method B (Becke line method) in JIS K 7142. A refractive index of the non-hollow polymer particles of 1.55 or more can improve whiteness of the heat-sensitive recording material. On the other hand, a refractive index of the non-hollow polymer particles of 1.65 or less can increase color density of the heat-sensitive recording material.

The content of the non-hollow polymer particles in the present invention is 25 to 60 mass %, preferably 30 to 50 mass, and more preferably 35 to 50 mass&, based on the total solids content of the light-scattering layer. A content of the non-hollow polymer particles of 25 mass& or more can improve whiteness of the heat-sensitive recording material. On the other hand, a content of the non-hollow polymer particles of 60 mass % or less can increase color density.

### Clarifying Agent

Due to the presence of a clarifying agent, when heat is applied, the clarifying agent undergoes melting, and the refractive index of the light-scattering layer changes, allowing the light-scattering layer to become transparent and the colored surface to become visible.

Specific examples of the clarifying agent include stearic acid amide, palmitic acid amide, aromatic oxalic acid ester, aromatic ethylene glycol ether, ethylene-bis-stearic acid amide, 1,2-diphenyloxyethane, 1,2-bis(3-methylphenoxy) ethane, dibenzyl oxalate, dibenzyl terephthalate, benzyl-biphenyl, benzyl-2-naphthyl ether, diphenyl sulfone, m-terphenyl, p-benzyloxybenzyl benzoate, cyclohexane dimethanol benzoate, p-toluenesulfonamide, o-toluenesulfonamide, 2,6-diisopropylnaphthalene, 4,4-diisopropylbiphenyl, and erucic acid amide. Of course, the clarifying agent is not limited to these, and two or more compounds may be used in combination as necessary.

For the clarifying agent, in particular, stearic acid amide and palmitic acid amide are preferred from the viewpoint of excellent printability, and combined use of stearic acid amide and palmitic acid amide is particularly preferred to increase color density.

The content of the clarifying agent is 10 to 40 mass %, preferably 20 to 35 mass %, and more preferably 20 to 30 mass %, based on the total solids content of the light-scattering layer. A content of 10 mass % or more can increase color density. A content to 40 mass % or less can improve printability.

The content of the clarifying agent is preferably 0.2 parts by mass or more, and more preferably 0.4 parts by mass or more, per part by mass the non-hollow polymer particles. On the other hand, the content of the clarifying agent is preferably 2.0 parts by mass or less, and more preferably 1.6 parts by mass or less, per part by mass of the non-hollow polymer particles.

### Hollow Polymer Particles

Due to the presence of hollow polymer particles, light scattering occurs in the light-scattering layer, making it possible to conceal the colored surface.

The hollow polymer particles conceal the colored surface in a more excellent manner than non-hollow polymer particles; however, the color density of the hollow polymer particles is less satisfactory than that of non-hollow polymer particles.

Other components used for constituting the light-scattering layer include a binder. Further, auxiliary agents, such as crosslinking agents, lubricants, water resistance improving agents, and dispersants, may be used, if necessary.

Examples of binders include water-soluble polymeric materials, such as polyvinyl alcohol and derivatives thereof, starch and derivatives thereof, cellulose derivatives, such as hydroxymethylcellulose, hydroxyethylcellulose, hydroxypropylcellulose, methylcellulose, and ethylcellulose, sodium polyacrylate, polyvinylpyrrolidone, acrylamide-acrylic acid ester copolymers, acrylamide-acrylic acid ester-methacrylic acid ester copolymers, styrene-maleic anhydride copolymers, isobutylene-maleic anhydride copolymers, casein, gelatin, and derivatives thereof; emulsions, such as polyvinyl acetate, polyurethane, polyacrylic acid, polyacrylic acid ester, vinyl chloride-vinyl acetate copolymers, polybutyl methacrylate, and ethylene-vinyl acetate copolymers; latexes of water-insoluble polymers, such as styrene-butadiene copolymers and styrene-butadiene-acrylic copolymers; and the like. Of these, polyvinyl alcohol, latexes, and the like are preferred. The content of the binder can be selected from a wide range, and is typically preferably about 7 to 50 mass %, and more preferably about 10 to 45 mass %, based on the total solids content of the light-scattering layer.

The presence of a crosslinking agent in the light-scattering layer can improve water resistance of the light-scattering layer. Examples of crosslinking agents include aldehyde compounds, such as glyoxal; polyamine compounds, such as polyethyleneimine; epoxy compounds, polyamide resins, melamine resins, glyoxylic acid salts, dimethylolurea compounds, aziridine compounds, block isocyanate compounds; inorganic compounds, such as ammonium persulfate, ferric chloride, magnesium chloride, soda tetraborate, and potassium tetraborate; boric acid, boric acid triesters, boron polymers, hydrazide compounds, glyoxylic acid salts, and the like. These may be used singly or in a combination of two or more.

Metal soaps may be used as lubricants. Examples of metal soaps include polyvalent metal salts of higher fatty acids, such as zinc stearate, aluminum stearate, calcium stearate, and zinc oleate.

The light-scattering layer is formed on a colored surface, for example, by dispersing in water as a dispersion medium a clarifying agent, together with a water-soluble synthetic polymer compound, such as polyacrylamide, polyvinyl pyrrolidone, polyvinyl alcohol, methylcellulose, or a styrene-maleic anhydride copolymer salt, and other additives such as a surfactant, with at least one of various stirrers or wet pulverizers, such as a ball mill, a co-ball mill, an attritor, or a vertical or horizontal sand mill, to form a dispersion; reducing the average particle diameter of the dispersion to 2 μm or less; mixing the resulting dispersion with non-hollow polymer particles, and optionally further mixing therewith a binder, an auxiliary agent, and the like to prepare a coating liquid for a light-scattering layer; applying the coating liquid for a light-scattering layer to the colored surface; and then drying. The coated amount of the coating liquid for a light-scattering layer is not particularly limited, and the coated amount is preferably about 1 to 15 g/m², more preferably about 2 to 10 g/m², even more preferably about 2.5 to 8 g/m², and particularly preferably about 3 to 5 g/m², in terms of the coated amount after drying. The light-scattering layer may be formed as two or more separate layers if necessary, and the composition and coated amount of each layer may be the same or different.

### Protective Layer

The heat-sensitive recording material can comprise a protective layer on the light-scattering layer as necessary. The protective layer preferably contains a pigment and a binder. The protective layer preferably further contains a lubricant, such as polyolefin wax or zinc stearate, for the purpose of preventing the layer from sticking to the thermal head. The protective layer can also contain a UV absorber. When a glossy protective layer is formed, the obtained product can have increased added value.

The pigment contained in the protective layer is not particularly limited. Examples include inorganic pigments, such as amorphous silica, kaolin, clay, light calcium carbonate, heavy calcium carbonate, calcined kaolin, titanium oxide, magnesium carbonate, aluminum hydroxide, colloidal silica, and synthetic layered mica; plastic pigments, such as urea-formalin resin fillers; and the like.

The binder contained in the protective layer is not particularly limited, and an aqueous binder selected from water-soluble binders and water-dispersible binders can be used. The binder can be appropriately selected from those that can be used for the light-scattering layer. Of these, various modified polyvinyl alcohols, such as acetoacetyl-modified polyvinyl alcohol, carboxy-modified polyvinyl alcohol, and diacetone-modified polyvinyl alcohol, can be more preferably used.

The protective layer is formed on the light-scattering layer, for example, by mixing a pigment and a binder optionally with an auxiliary agent and the like using water as a dispersion medium to prepare a coating liquid for a protective layer, applying the coating liquid to the light-scattering layer, and then drying. The coated amount of the coating liquid for a protective layer is not particularly limited, and is preferably about 0.3 to 15 g/m², more preferably about 0.3 to 10 g/m², even more preferably about 0.5 to 8 g/m², particularly preferably about 1 to 8 g/m², and further particularly preferably about 1 to 5 g/m², in terms of dry mass. The protective layer may be formed as two or more separate layers if necessary, and the composition and coated amount of each layer may be the same or different.

### Other Layers

In the present invention, the heat-sensitive recording material preferably comprises an adhesive layer on at least one surface of the support. This can increase the added value of the heat-sensitive recording material. For example, adhesive paper, remoistening adhesive paper, or delayed tack paper can be formed as the adhesive layer by subjecting one surface of the support to coating with, for example, an adhesive, such as an adhesive, a remoistening adhesive, or a delayed tack adhesive. Recording paper capable of two-sided recording can also be formed by imparting to the surface of the support opposite to the light-scattering layer a function as heat transfer paper, ink jet recording paper, carbon-free paper, electrostatic recording paper, or xerography paper. Of course, the heat-sensitive recording material can be formed into a two-side heat-sensitive recording material. A back layer can also be provided to inhibit oil and plasticizer permeation from the back side of the heat-sensitive recording material, or for curl control and antistatic purposes. The heat-sensitive recording material can also be formed into linerless labels that do not require release paper by forming a silicone-containing release layer on the protective layer and applying an adhesive to the one side.

### Heat-Sensitive Recording Material

The heat-sensitive recording material can be produced by forming each layer described above on the support. Any known coating method, such as an air knife method, a blade method, a gravure method, a roll coater method, a spray method, a dip method, a bar method, a curtain method, a slot-die method, a slide die method, and an extrusion method, can be used as the method for forming each layer described above on the support. The individual coating compositions may be applied in such a manner that a first coating composition is applied and dried and then a second coating composition is applied and dried to form one layer after another, or the same coating composition may be applied separately to form two or more layers. Further, simultaneous multilayer coating may also be performed, in which individual coating compositions are applied all at once to form two or more layers simultaneously. In any stage after each layer is formed or after all layers are formed, the layer may be subjected to a smoothing treatment by a known method, such as supercalendering or soft calendering.

### B. Heat-Sensitive Recording Material (B)

In the present invention, the heat-sensitive recording material comprises a support having at least one colored surface, and a light-scattering layer on the colored surface, wherein the light-scattering layer contains at least hollow polymer particles, a clarifying agent, and an inorganic pigment, and the light-scattering layer is substantially free of a dye precursor and a developer.

### Support

The support for use in this embodiment may be the support described in the “Support” section in “A. Heat-sensitive Recording Material (A)” above.

### Light-Scattering Layer

The heat-sensitive recording material of the present invention comprises a light-scattering layer on the colored surface. The light-scattering layer contains at least hollow polymer particles, a clarifying agent, and an inorganic pigment. The light-scattering layer is substantially free of a dye precursor and a developer.

### Hollow Polymer Particles

Due to the presence of hollow polymer particles, light scattering occurs in the light-scattering layer, making it possible to conceal the colored surface. The presence of hollow polymer particles can increase whiteness.

The hollow polymer particles can be divided into foamed and non-foamed types depending on the production method. Of these two types, foamed hollow polymer particles typically have a larger average particle diameter and a higher hollow ratio than non-foamed hollow polymer particles.

Non-foamed hollow polymer particles can be produced by polymerizing a seed in a solution, polymerizing another resin so as to cover the seed, and removing the seed inside by swelling and dissolving to form a void inside. An alkaline aqueous solution or the like is used to remove the seed inside by swelling and dissolving. Non-foamed hollow particles with a relatively small average particle diameter can also be produced by alkaline swelling treatment of core-shell particles in which core particles having alkaline swelling properties are coated with a shell layer that does not have alkaline swelling properties.

Foamed hollow polymer particles can be produced by preparing particles in which a volatile liquid is sealed in a resin, and vaporizing and expanding the liquid in the particles while softening the resin by heating.

The hollow ratio of the hollow polymer particles is, for example, about 30 to 998, The hollow ratio as used herein is a value that is determined according to the following formula: (d³/D³)×100. In the formula, d represents the inner diameter of the hollow polymer particles, and D represents the outer diameter of the hollow polymer particles.

The average particle diameter of the hollow polymer particles in the present invention is preferably 0.2 to 5.0 μm, and more preferably 0.4 to 2.0 μm. The average particle diameter as used herein is the diameter at which the volume of larger particles is equal to the volume of smaller particles when particles are divided into two kinds based on the particle diameter, i.e., the median diameter, which is the particle diameter corresponding to 50 volumes frequency. The average particle diameter is also referred to as “D50.” The average particle diameter (D50) of the hollow polymer particles can be measured using a laser diffraction particle diameter distribution analyzer. The average particle diameter may also be indicated by the average value of the particle diameter of 10 particles measured from a particle image (SEM image) of an electron microscope.

The content of the hollow polymer particles in the present invention is preferably 6 to 35 mass %, more preferably 10 to 30 mass %, and even more preferably 20 to 30 mass %, based on the total solids content of the light-scattering layer. A content of the hollow polymer particles of 6 mass % or more can improve whiteness. On the other hand, a content of the hollow polymer particles of 35 mass % or less can increase color density and also improve printability.

### Clarifying Agent

Due to the presence of the clarifying agent, when heat is applied, the clarifying agent undergoes melting, and the refractive index of the light-scattering layer changes, allowing the light-scattering layer to become transparent and the colored surface to become visible.

Specific examples of the clarifying agent include myristic acid amide, stearic acid amide, palmitic acid amide, arachidonic acid amide, behenic acid amide, aromatic oxalic acid ester, aromatic ethylene glycol ether, ethylene-bis-stearic acid amide, 1,2-diphenyloxyethane, 1,2-bis(3-methylphenoxy) ethane, 1,2-bis(phenoxymethyl)benzene, dibenzyl oxalate, dibenzyl terephthalate, benzyl-biphenyl, benzyl-2-naphthyl ether, diphenyl sulfone, m-terphenyl, p-benzyloxybenzyl benzoate, cyclohexane dimethanol benzoate, p-toluenesulfonamide, o-toluenesulfonamide, 2,6-diisopropylnaphthalene, 4,4-diisopropylbiphenyl, erucic acid amide, oxalic acid-di-p-chlorobenzyl ester, oxalic acid-di-p-methylbenzyl ester, and the like. Of course, the clarifying agent is not limited to these, and two or more compounds may be used in combination as necessary.

From the viewpoint of excellent printability, it is preferred that the clarifying agent
A) consists of a fatty acid amide, or
B) comprises a combination of a fatty acid amide and at least one member selected from the group consisting of a compound represented by formula (1) and 1,2-bis(phenoxymethyl)benzene,

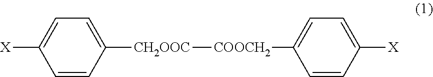

In the formula, Xs are the same or different, and each represents CH₃ or Cl. This configuration can improve printability.

Examples of fatty acid amides include myristic acid amide, palmitic acid amide, stearic acid amide, arachidic acid amide, behenic acid amide, and the like. Of these, stearic acid amide and palmitic acid amide are preferred from the viewpoint of excellent printability, and combined use of stearic acid amide and palmitic acid amide is particularly preferred to increase color density. Of course, fatty acid amides are not limited to these, and two or more compounds may be used in combination as necessary.

The compound represented by formula (1) is not particularly limited, and may be at least one member selected from the group consisting of oxalic acid-di-p-chlorobenzyl ester and oxalic acid-di-p-methylbenzyl ester.

The content of the clarifying agent is not particularly limited, and is preferably about 20 to 35 masse, and more preferably about 25 to 30 mass %, based on the total solids content of the light-scattering layer. A content of 20 masse or more can increase color density. A content of 35 mass % or less can increase color density and also improve printability.

The content of the clarifying agent is preferably 1 part by mass or more per part by mass of the hollow polymer particle. In the case of A) above, the content of the clarifying agent is preferably 3.5 parts by mass or less, more preferably 2.5 parts by mass or less, and even more preferably 1.5 parts by mass or less, per part by mass of the hollow polymer particles. On the other hand, in the case of B) above, the content of the clarifying agent is preferably 4 parts by mass or less, more preferably 3 parts by mass or less, and even more preferably 2 parts by mass or less, per part by mass of the hollow polymer particles. A content of 1 part by mass or more can increase color density.

### Inorganic Pigment

The presence of an inorganic pigment can prevent the clarifying agent from adhering to the thermal head (head residue).

From the viewpoint of effectively reducing printing problems, such as the occurrence of head residue, the oil absorption of the inorganic pigment is preferably 100 ml/100 g or more, more preferably 120 ml/100 g or more, and even more preferably 150 ml/100 g or more. On the other hand, from the viewpoint of increasing recording density, the oil absorption of the inorganic pigment is preferably 240 ml/100 g or less, more preferably 200 ml/100 g or less, and even more preferably 180 ml/100 g or less. The oil absorption is a value determined according to the method in JIS K 5101.

Various oil-absorbing pigments can be used as the oil-absorbing pigments. Specific examples include inorganic pigments, such as calcium carbonate, such as light calcium carbonate, aluminum hydroxide, silica, amorphous silica, clay, such as calcined kaolin and kaolin, and talc. Of these, calcium carbonate and aluminum hydroxide are preferred from the viewpoint of abrasion of the thermal head surface.

The average particle diameter of the primary particles of the inorganic pigment in the present invention is preferably about 0.2 to 0.7 μm, and, in particular, more preferably about 0.3 to 0.6 μm. An average particle diameter of 0.2 μm or more can improve properties of scraping head residues. An average particle diameter of 0.7 μm or less can improve head abrasion resistance.

The content of the inorganic pigment is not particularly limited, and is preferably about 10 to 25 mass %, and more preferably about 12 to 20 mass %, based on the total solids content of the light-scattering layer. A content of 10 mass % or more can improve printability. A content to 25 mass % or less can increase color density,

### Non-Hollow Polymer Particles

The light-scattering layer in the present invention can contain non-hollow polymer particles. The presence of non-hollow polymer particles can increase color density.

Resins that can be used for the non-hollow polymer particles typically include acrylic resins and polystyrene resins. In particular, styrene-acrylic copolymers are preferred.

Other components used for constituting the light-scattering layer include a binder. Further, auxiliary agents, such as crosslinking agents, lubricants, water resistance improving agents, and dispersants, may be used, if necessary. The binder, crosslinking agent, and lubricant for use may be the binder, crosslinking agent, and lubricant described in the “Light-scattering Layer” section in “A. Heat-sensitive Recording Material (A)” above.

The content of the binder can be selected from a wide range, and is typically preferably about 7 to 60 mass %, and more preferably about 10 to 45 mass %, based on the total solids content of the light-scattering layer.

The light-scattering layer is formed on a colored surface, for example, by dispersing in water as a dispersion medium a clarifying agent, together with a water-soluble synthetic polymer compound, such as polyacrylamide, polyvinyl pyrrolidone, polyvinyl alcohol, methylcellulose, or a styrene-maleic anhydride copolymer salt, and other additives such as a surfactant, with at least one of various stirrers or wet pulverizers, such as a ball mill, a co-ball mill, an attritor, or a vertical or horizontal sand mill, to form a dispersion; reducing the average particle diameter of the dispersion to 2 μm or less; mixing the resulting dispersion with hollow polymer particles, and optionally further mixing therewith a binder, non-hollow polymer particles, an auxiliary agent, and the like to prepare a coating liquid for a light-scattering layer; applying the coating liquid for a light-scattering layer to the colored surface; and then drying. The coated amount of the coating liquid for a light-scattering layer is not particularly limited, and the coated amount is preferably about 1 to 15 g/m², more preferably about 2 to 10 g/m², even more preferably about 2.5 to 8 g/m², and particularly preferably about 3 to 5 g/m², in terms of the coated amount after drying. The light-scattering layer may be formed as two or more separate layers if necessary, and the composition and coated amount of each layer may be the same or different.

### Protective Layer

The heat-sensitive recording material can comprise a protective layer on the light-scattering layer as necessary. The protective layer for use may be the protective layer described in the “Protective Layer” section in “A. Heat-sensitive Recording Material (A)” above,

### Other Layers

In this embodiment, the heat-sensitive recording material can be further processed to impart higher functionality to it for enhanced added value. Other layers for use can be those described in the “Other Layers” section in “A. Heat-sensitive Recording Material (A)” above.

### Heat-Sensitive Recording Material

The heat-sensitive recording material can be produced by forming the individual layers described above on a support. The method for forming the layers can be the method described in the “Heat-sensitive Recording Material” section in “A. Heat-sensitive Recording Material (A)” above.

### EXAMPLES

Below, the present invention is described in more detail with reference to Examples. However, the present invention is not limited to these Examples. In the Examples, “parts” and “%” represent “parts by mass” and “mass %” unless otherwise specified. The particle diameters were measured with a SALD2200 laser diffraction particle diameter distribution analyzer (produced by Shimadzu Corporation). “Average particle diameter” as used herein refers to a median diameter (D50).

The refractive index of non-hollow polymer particles was measured under the following conditions.
Test method: JIS K 7142, B method (Becke line method)
Measurement conditions: Immersion solution: aqueous solution of potassium tetraiodomercurate (II), test temperature: 23° C., light source: Na light source (D line/589 nm)
Equipment used: Abbe refractometer 2T (produced by Atago Co., Ltd.) and small measuring microscope STM5-311 (produced by Olympus Corporation, observation magnification: 400×)

### A. Heat-Sensitive Recording Material (A)

### Example A1

### (1) Preparation of Coating Liquid for Colored Layer

A coating liquid for a colored layer was obtained by mixing a composition comprising 169.8 parts of a plastic hollow particle dispersion (trade name: Ropaque SN-1055, hollow ratio: 55%, average particle diameter: 1.0 μm, produced by The Dow Chemical Company, solids concentration: 26.5 mass %), 40.0 parts of a 50% aqueous dispersion (average particle diameter: 0.6 μm) of calcined kaolin (trade name: Ansilex 93, produced by BASF), 41.7 parts of a styrene-butadiene-based latex (trade name: L-1571, produced by Asahi Kasei Chemicals Corporation, solids concentration: 48 mass %), 50.0 parts of a 10% aqueous solution of oxidized starch, 26.3 parts of a carbon black dispersion (trade name: Black FLTB, produced by Dainichiseika Color & Chemicals Mfg, Co., Ltd., solids concentration: 38.0%), and 20 parts of water.

### (2) Preparation of Fatty Acid Amide Dispersion

12.5 parts of stearic acid amide, 12.5 parts of palmitic acid amide, 25.0 parts of a 10% aqueous solution of partially saponified PVA (trade name: Kuraray Poval 5-88, produced by Kuraray Co., Ltd.), and 50 parts of water were mixed. The resulting mixture was pulverized with a sand mill (produced by Aimex Co., Ltd.; a sand grinder) to a median diameter measured with a SALD2200 laser diffraction particle diameter distribution analyzer (produced by Shimadzu Corporation) of 1.0 μm, thereby obtaining a clarifying agent dispersion.

### (3) Preparation of Coating Liquid for Light-Scattering Layer

A coating liquid for a light-scattering layer was obtained by mixing a composition comprising 75.5 parts of a non-hollow polymer particle dispersion (trade name: Glossdell 130S, average particle diameter: 0.7 μm, produced by Mitsui Chemicals, Inc., solids concentration: 53.0%, refractive index: 1.58), 100.0 parts of the fatty acid amide dispersion obtained in (2), 225.0 parts of a 10.0% aqueous solution of fully saponified PVA (trade name: Kuraray Poval 11-98, produced by Kuraray Co., Ltd.), 27.8 parts of an aqueous dispersion of zinc stearate (trade name: Hidorin Z-9-36, produced by Chukyo Yushi Co., Ltd., solids concentration: 36.0%), and 50.0 parts of water.

### (4) Preparation of Heat-Sensitive Recording Material

The coating liquid for a colored layer and the coating liquid for a light-scattering layer were applied to one surface of high-quality paper having a basis weight of 42 g/m² and dried so that the coated amounts were 6.0 g/m² and 5.0 g/m², respectively, in terms of the coated amounts after drying to form a colored layer and a light-scattering layer in this order, thereby obtaining a heat-sensitive recording material.

### Example A2

A heat-sensitive recording material was obtained in the same manner as in Example A1, except that in the preparation of the coating liquid for a light-scattering layer in Example A1, the amount of the non-hollow polymer particle dispersion (trade name: Glossdell 130S, average particle diameter: 0.7 μm, produced by Mitsui Chemicals, Inc., solids concentration: 53.0%, refractive index: 1.58) was changed from 75.5 parts to 47.2 parts, and the amount of the 10.0% aqueous solution of fully saponified PVA (trade name: Kuraray Poval 11-98, produced by Kuraray Co., Ltd.) was changed from 225.0 parts to 375.0 parts.

### Example A3

A heat-sensitive recording material was obtained in the same manner as in Example A1, except that in the preparation of the coating liquid for a light-scattering layer in Example A1, the amount of the non-hollow polymer particle dispersion (trade name: Glossdell 130S, average particle diameter: 0.7 μm, produced by Mitsui Chemicals, Inc., solids concentration: 53.0%, refractive index: 1.58) was changed from 75.5 parts to 113.2 parts, and the amount of the 10.0% aqueous solution of fully saponified PVA (trade name: Kuraray Poval 11-98, produced by Kuraray Co., Ltd.) was changed from 225.0 parts to 25.0 parts.

### Example A4

A heat-sensitive recording material was obtained in the same manner as in Example A1, except that in the preparation of the coating liquid for a light-scattering layer in Example A1, the amount of the fatty acid amide dispersion obtained in (2) was changed from 100.0 parts to 160.0 parts, and the amount of the 10.0% aqueous solution of fully saponified PVA (trade name: Kuraray Poval 11-98, produced by Kuraray Co., Ltd.) was changed from 225.0 parts to 60.0 parts.

### Example A5

A heat-sensitive recording material was obtained in the same manner as in Example A1, except that in the preparation of the coating liquid for a light-scattering layer in Example A1, the amount of the fatty acid amide dispersion obtained in (2) was changed from 100.0 parts to 40.0 parts, and the amount of the 10.0% aqueous solution of fully saponified PVA (trade name: Kuraray Poval 11-98, produced by Kuraray Co., Ltd.) was changed from 225.0 parts to 390.0 parts.

### Example A6

A heat-sensitive recording material was obtained in the same manner as in Example A1, except that in the preparation of the fatty acid amide dispersion in Example A1, the amount of stearic acid amide was changed from 12.5 parts to 25.0 parts, and the amount of palmitic acid amide was changed from 12.5 parts to 0 parts.

### Example A7

A heat-sensitive recording material was obtained in the same manner as in Example A1, except that in the preparation of the fatty acid amide dispersion in Example A1, the amount of stearic acid amide was changed from 12.5 parts to 0 parts, and the amount of palmitic acid amide was changed from 12.5 parts to 25.0 parts.

### Example A8

A heat-sensitive recording material was obtained in the same manner as in Example A1, except that in the preparation of the coating liquid for a light-scattering layer in Example A1, 56.8 parts of the clarifying agent dispersion prepared as described in (5) below was used instead of 100.0 parts of the fatty acid amide dispersion obtained in (2).

### (5) Preparation of Clarifying Agent Dispersion

44 parts of oxalic acid-di-p-methylbenzyl ester, 44 parts of a 10% aqueous solution of partially saponified PVA (trade name: Kuraray Poval 5-88, produced by Kuraray Co., Ltd.), and 12 parts of water were mixed. The resulting mixture was pulverized with a sand mill (produced by Aimex Co., Ltd.; a sand grinder) to a median diameter measured with a SALD2200 laser diffraction particle diameter distribution analyzer (produced by Shimadzu Corporation) of 1.0 μm, thereby obtaining a clarifying agent dispersion.

### Example A9

A heat-sensitive recording material was obtained in the same manner as in Example A8, except that in the preparation of the clarifying agent dispersion in Example A8, diphenyl sulfone was used instead of oxalic acid-di-p-methylbenzyl ester.

### Example A10

A heat-sensitive recording material was obtained in the same manner as in Example A8, except that in the preparation of the clarifying agent dispersion in Example A8, 1,2-bis(3-methylphenoxy) ethane was used instead of oxalic acid-di-p-methylbenzyl ester.

### Example A11

A heat-sensitive recording material was obtained in the same manner as in Example A1, except that in the preparation of the coating liquid for a light-scattering layer in Example A1, the amount of the fatty acid amide dispersion obtained in (2) was changed from 100.0 parts to 40 parts, and further that 34.1 parts of the clarifying agent dispersion prepared as described in (5) was used.

### Example A12

A heat-sensitive recording material was obtained in the same manner as in Example A1, except that in the preparation of the coating liquid for a light-scattering layer in Example A1, 114.3 parts of a non-hollow polymer particle dispersion (trade name: Glossdell 204S, average particle diameter: 0.2 μm, produced by Mitsui Chemicals, Inc., solids concentration: 35.0 mass %, refractive index: 1.58) was used instead of 75.5 parts of the non-hollow polymer particle dispersion (trade name: Glossdell 130S, average particle diameter: 0.7 μm, produced by Mitsui Chemicals, Inc., solids concentration: 53.0%, refractive index: 1.58).

### Example A13

A heat-sensitive recording material was obtained in the same manner as in Example A1, except that in the preparation of the coating liquid for a light-scattering layer in Example A1, 137.0 parts of a non-hollow polymer particle dispersion (trade name: Saivinol PG-5, average particle diameter: 3.0 μm, produced by Saiden Chemical Industry Co., Ltd., solids concentration: 29.2 mass %, refractive index: 1.58) was used instead of 75.5 parts of the non-hollow polymer particle dispersion (trade name: Glossdell 130S, average particle diameter: 0.7 μm, produced by Mitsui Chemicals, Inc., solids concentration: 53.0%, refractive index: 1.58).

### Example A14

A heat-sensitive recording material was obtained in the same manner as in Example A1, except that in the preparation of the coating liquid for a light-scattering layer in Example A1, 150.9 parts of a non-hollow polymer particle dispersion (trade name: Saivinol PG-2, average particle diameter: 5.0 μm, produced by Saiden Chemical Industry Co., Ltd., solids concentration: 26.5 mass %, refractive index: 1.58) was used instead of 75.5 parts of the non-hollow polymer particle dispersion (trade name: Glossdell 130S, average particle diameter: 0.7 μm, produced by Mitsui Chemicals, Inc., solids concentration: 53.0%, refractive index: 1.58).

### Example A15

A heat-sensitive recording material was obtained in the same manner as in Example A1, except that in the preparation of the coating liquid for a light-scattering layer in Example A1, 200.0 parts of an aqueous dispersion (solids concentration: 20.0 mass %) of non-hollow polymer particles (trade name: Epostar MV1002, average particle diameter: 2.0 μm, produced by Nippon Shokubai Co., Ltd., refractive index: 1.51) was used instead of 75.5 parts of the non-hollow polymer particle dispersion (trade name: Glossdell 130S, average particle diameter: 0.7 μm, produced by Mitsui Chemicals, Inc., solids concentration: 53.0%, refractive index: 1.58).

### Example A16

A heat-sensitive recording material was obtained in the same manner as in Example A1, except that in the preparation of the coating liquid for a light-scattering layer in Example A1, 200.0 parts of an aqueous dispersion (solids concentration: 20.0 mass %) of non-hollow polymer particles (trade name: Epostar MS, average particle diameter: 2.0 μm, produced by Nippon Shokubai Co., Ltd., refractive index: 1.66) was used instead of 75.5 parts of the non-hollow polymer particle dispersion (trade name: Glossdell 130S, average particle diameter: 0.7 μm, produced by Mitsui Chemicals, Inc., solids concentration: 53.0%, refractive index: 1.58).

### Comparative Example A1

A heat-sensitive recording material was obtained in the same manner as in Example A1, except that in the preparation of the coating liquid for a light-scattering layer in Example A1, 135.6 parts of a plastic hollow particle dispersion (trade name: Ropaque Ultra-E, hollow ratio: 44%, average particle diameter: 0.4 μm, produced by The Dow Chemical Company, solids concentration: 29.5 mass %) was used instead of 75.5 parts of the non-hollow polymer particle dispersion (trade name: Glossdell 130S, average particle diameter: 0.7 μm, produced by Mitsui Chemicals, Inc., solids concentration: 53.0 mass %).

### Comparative Example A2

A heat-sensitive recording material was obtained in the same manner as in Example A1, except that in the preparation of the coating liquid for a light-scattering layer in Example A1, the amount of the non-hollow polymer particle dispersion (trade name: Glossdell 130S, average particle diameter: 0.7 μm, produced by Mitsui Chemicals, Inc., solids concentration: 53.0%, refractive index: 1.58) was changed from 75.5 parts to 28, 3 parts, and the amount of the 10.0% aqueous solution of fully saponified PVA (trade name: Kuraray Poval 11-98, produced by Kuraray Co., Ltd.) was changed from 225.0 parts to 475.0 parts.

### Comparative Example A3

A heat-sensitive recording material was obtained in the same manner as in Example A1, except that in the preparation of the coating liquid for a light-scattering layer in Example A1, the amount of the non-hollow polymer particle dispersion (trade name: Glossdell 130S, average particle diameter: 0.7 μm, produced by Mitsui Chemicals, Inc., solids concentration: 53.0%, refractive index: 1.58) was changed from 75.5 parts to 122.6 parts, and the amount of the 10.0% aqueous solution of fully saponified PVA (trade name: Kuraray Poval 11-98, produced by Kuraray Co., Ltd.) was changed from 225.0 parts to 25.0 parts.

### Comparative Example A4

A heat-sensitive recording material was obtained in the same manner as in Example A1, except that in the preparation of the coating liquid for a light-scattering layer in Example A1, the amount of the fatty acid amide dispersion obtained in (2) was changed from 100.0 parts to 20.0 parts, and the amount of the 10.0% aqueous solution of fully saponified PVA (trade name: Kuraray Poval 11-98, produced by Kuraray Co., Ltd.) was changed from 225.0 parts to 445.0 parts.

### Comparative Example A5

A heat-sensitive recording material was obtained in the same manner as in Example A1, except that in the preparation of the coating liquid for a light-scattering layer in Example A1, the amount of the fatty acid amide dispersion obtained in (2) was changed from 100.0 parts to 180.0 parts, and the amount of the 10.0% aqueous solution of fully saponified PVA (trade name: Kuraray Poval 11-98, produced by Kuraray Co., Ltd.) was changed from 225.0 parts to 5.0 parts.

The Examples and Comparative Examples above were evaluated according to the following methods. Table 1 shows the results.

### ISO Whiteness

Four sheets of each of the obtained heat-sensitive recording materials were stacked, and the ISO whiteness was measured with an SC-WT color meter (produced by Suga Test Instruments Co., Ltd.), The ISO whiteness is required to be 35 or more, and preferably 40 or more.

### Print Density

Recording was performed on each heat-sensitive recording material at an applied energy of 0.24 mJ/dot by using a thermal recording tester (trade name: TH-PMD, produced by Ohkura Electric Co., Ltd.). The obtained printed portion was measured with a Macbeth densitometer (RD-914, produced by Macbeth Co., Ltd.) in visual mode. A larger value indicates a higher print density. The recording density is required to be 1.30 or more, and preferably 1.40 or more.

### Printability

Solid black printing (18 cm) was performed 6 times at an applied energy of 3 A by using a thermal printer (trade name: L′esprit T-408v-ex, produced by Sato Corporation), and the amount of head residue adhering to the thermal head was evaluated according to the following criteria.
A: A very small amount of head residue was observed, and there was no problem in practical use.
B: Adhesion of head residue was observed, but there was no problem in practical use.
C: A large amount of head residue was observed, and printing problems occurred; there was a problem in practical use.

TABLE 1

| | Particle | | | | | | | | | | |
|---|---|---|---|---|---|---|---|---|---|---|---|
| | diameter/ | | | | | | | | | | |
| | refractive | Ex. | Ex. | Ex. | Ex. | Ex. | Ex. | Ex. | Ex. | Ex. | Ex. |
| | index | A1 | A2 | A3 | A4 | A5 | A6 | A7 | A8 | A9 | A10 |
| Non-hollow polymer particles | | | | | | | | | | | |
| Glossdell 130S | 0.7 μm/1.58 | 40 | 25 | 60 | 40 | 40 | 40 | 40 | 40 | 40 | 40 |
| Glossdell 204S | 0.2 μm/1.58 | | | | | | | | | | |
| Saivinol PG-5 | 3.0 μm/1.58 | | | | | | | | | | |
| Saivinol PG-2 | 5.0 μm/1.58 | | | | | | | | | | |
| Epostar MV1002 | 2.0 μm/1.51 | | | | | | | | | | |
| Epostar MS | 2.0 μm/1.66 | | | | | | | | | | |
| Hollow polymer particles | | | | | | | | | | | |
| Ropaque Ultra-E | | | | | | | | | | | |
| Clarifying agent | | | | | | | | | | | |
| Stearic acid amide | | 12.5 | 12.5 | 12.5 | 20 | 5 | 25 | | | | |
| Palmitic acid amide | | 12.5 | 12.5 | 12.5 | 20 | 5 | | 25 | | | |
| Oxalic acid-di-p-methylbenzyl ester | | | | | | | | | 25 | | |
| Diphenyl sulfone | | | | | | | | | | 25 | |
| 1,2-Di(3-methylphenoxy)ethane | | | | | | | | | | | 25 |
| Binder | | 25 | 40 | 5 | 10 | 40 | 25 | 25 | 25 | 25 | 25 |
| Wax | | 10 | 10 | 10 | 10 | 10 | 10 | 10 | 10 | 10 | 10 |
| Total | | 100 | 100 | 100 | 100 | 100 | 100 | 100 | 100 | 100 | 100 |
| ISO whiteness | | 44 | 36 | 49 | 44 | 44 | 44 | 44 | 44 | 44 | 44 |
| Print density | | 1.42 | 1.49 | 1.32 | 1.48 | 1.33 | 1.37 | 1.38 | 1.44 | 1.45 | 1.44 |
| Printability | | A | A | A | B | A | A | A | B | B | B |

| | Particle | | | | | |
|---|---|---|---|---|---|---|
| | diameter/ | | | | | |
| | refractive | Ex. | Ex. | Ex. | Ex. | Ex. |
| | index | A11 | A12 | A13 | A14 | A15 |
| Non-hollow polymer particles | | | | | | |
| Glossdell 130S | 0.7 μm/1.58 | 40 | | | | |
| Glossdell 204S | 0.2 μm/1.58 | | 40 | | | |
| Saivinol PG-5 | 3.0 μm/1.58 | | | 40 | | |
| Saivinol PG-2 | 5.0 μm/1.58 | | | | 40 | |
| Epostar MV1002 | 2.0 μm/1.51 | | | | | 40 |
| Epostar MS | 2.0 μm/1.66 | | | | | |
| Hollow polymer particles | | | | | | |
| Ropaque Ultra-E | | | | | | |
| Clarifying agent | | | | | | |
| Stearic acid amide | | 5 | 12.5 | 12.5 | 12.5 | 12.5 |
| Palmitic acid amide | | 5 | 12.5 | 12.5 | 12.5 | 12.5 |
| Oxalic acid-di-p-methylbenzyl ester | | 15 | | | | |
| Diphenyl sulfone | | | | | | |
| 1,2-Di(3-methylphenoxy)ethane | | | | | | |
| Binder | | 25 | 25 | 25 | 25 | 25 |
| Wax | | 10 | 10 | 10 | 10 | 10 |
| Total | | 100 | 100 | 100 | 100 | 100 |
| ISO whiteness | | 44 | 42 | 41 | 38 | 36 |
| Print density | | 1.44 | 1.45 | 1.45 | 1.46 | 1.48 |
| Printability | | A | A | A | A | A |

| | Ex. | Comp. | Comp. | Comp. | Comp. | Comp. |
|---|---|---|---|---|---|---|
| | A16 | Ex. A1 | Ex. A2 | Ex. A3 | Ex. A4 | Ex. A5 |
| Non-hollow polymer particles | | | | | | |
| Glossdell 130S | | | 15 | 65 | 40 | 40 |
| Glossdell 204S | | | | | | |
| Saivinol PG-5 | | | | | | |
| Saivinol PG-2 | | | | | | |
| Epostar MV1002 | | | | | | |
| Epostar MS | 40 | | | | | |
| Hollow polymer particles | | | | | | |
| Ropaque Ultra-E | | 40 | | | | |
| Clarifying agent | | | | | | |
| Stearic acid amide | 12.5 | 12.5 | 12.5 | 12.5 | 2.5 | 22.5 |
| Palmitic acid amide | 12.5 | 12.5 | 12.5 | 12.5 | 2.5 | 22.5 |
| Oxalic acid-di-p-methylbenzyl ester | | | | | | |
| Diphenyl sulfone | | | | | | |
| 1,2-Di(3-methylphenoxy)ethane | | | | | | |
| Binder | 25 | 25 | 50 | 5 | 45 | 5 |
| Wax | 10 | 10 | 10 | 5 | 10 | 10 |
| Total | 100 | 100 | 100 | 100 | 100 | 100 |
| ISO whiteness | 45 | 51 | 29 | 53 | 44 | 44 |
| Print density | 1.31 | 1.25 | 1.53 | 1.22 | 1.24 | 1.52 |
| Printability | A | A | A | A | A | C |

### B. Heat-Sensitive Recording Material (B)

### Example B1

### (1) Preparation of Coating Liquid for Colored Layer

A coating liquid for a colored layer was obtained by mixing a composition comprising 169.8 parts of a plastic hollow particle dispersion (trade name: Ropaque SN-1055, hollow ratio: 55%, average particle diameter: 1.0 μm, produced by The Dow Chemical Company, solids concentration: 26.5 mass %), 40.0 parts of a 50% aqueous dispersion (average particle diameter: 0.6 μm) of calcined kaolin (trade name: Ansilex 93, produced by BASF), 41.7 parts of a styrene-butadiene-based latex (trade name: L-1571, produced by Asahi Kasei Chemicals Corporation, solids concentration: 48 mass %), 50.0 parts of a 10% aqueous solution of oxidized starch, 26.3 parts of a carbon black dispersion (trade name: Black FLTB, produced by Dainichiseika Color & Chemicals Mfg. Co., Ltd., solids concentration: 38.0%), and 20 parts of water.

### (2) Preparation of Fatty Acid Amide Dispersion

12.5 parts of stearic acid amide, 12.5 parts of palmitic acid amide, 25.0 parts of a 10% aqueous solution of partially saponified PVA (trade name: Kuraray Poval 5-88, produced by Kuraray Co., Ltd.), and 50 parts of water were mixed. The resulting mixture was pulverized with a sand mill (produced by Aimex Co., Ltd.; a sand grinder) to a median diameter measured with a SALD2200 laser diffraction particle diameter distribution analyzer (produced by Shimadzu Corporation) of 1.0 μm, thereby obtaining a clarifying agent dispersion.

### (3) Preparation of Coating Liquid for Light-Scattering Layer

A coating liquid for a light-scattering layer was obtained by mixing a composition comprising 101.7 parts of a plastic hollow particle dispersion (trade name: Ropaque Ultra-E, hollow ratio: 44%, average particle diameter: 0.4 μm, produced by The Dow Chemical Company, solids concentration: 29.5 mass %), 50.8 parts of fine silica (trade name: Silojet A30X, average particle diameter: 0.3 μm, produced by Grace Co., solids concentration: 29.5 mass %, oil absorption: 180 ml/100 g), 120.0 parts of the fatty acid amide dispersion obtained in (2), 9.4 parts of non-hollow polymer particles (trade name: Glossdell 130S, average particle diameter: 0.6 μm, produced by Mitsui Chemicals, Inc., solids concentration: 53.0 mass %), 70.0 parts of a 10.0% aqueous solution of fully saponified PVA (trade name: Kuraray Poval 11-98, produced by Kuraray Co., Ltd.), 27.8 parts of an aqueous dispersion of zinc stearate (trade name: Hidorin Z-9-36, produced by Chukyo Yushi Co., Ltd., solids concentration: 36.0%), and 50.0 parts of water.

### (4) Preparation of Heat-Sensitive Recording Material

The coating liquid for a colored layer and the coating liquid for a light-scattering layer were applied to one surface of high-quality paper having a basis weight of 42 g/m² and dried so that the coated amounts were 6.0 g/m² and 3.5 g/m², respectively, in terms of the coated amounts after drying to form a colored layer and a light-scattering layer in this order, thereby obtaining a heat-sensitive recording material

### Example B2

A heat-sensitive recording material was obtained in the same manner as in Example B1, except that in the preparation of the coating liquid for a light-scattering layer in Example B1, 15.0 parts of amorphous silica (trade name: Nipsil E-743, particle diameter: 1.5 μm, produced by Tosoh Silica Corporation, powder, oil absorption: 170 ml/100 g) was used instead of 50.8 parts of fine silica (trade name: Silojet A30X, average particle diameter: 0.3 μm, produced by Grace Co., solids concentration: 29.5 mass %, oil absorption: 180 ml/100 g).

### Example B3

A heat-sensitive recording material was obtained in the same manner as in Example B1, except that in the preparation of the coating liquid for a light-scattering layer in Example B1, 15.0 parts of calcined kaolin (trade name: Ansilex 93, particle diameter: 2.0 μm, produced by BASF, powder, oil absorption: 104 ml/100 g) was used instead of 50.8 parts of fine silica (trade name: Silojet A30X, average particle diameter: 0.3 μm, produced by Grace Co., solids concentration: 29.5 mass %, oil absorption: 180 ml/100 g).

### Example B4

A heat-sensitive recording material was obtained in the same manner as in Example B1, except that in the preparation of the coating liquid for a light-scattering layer in Example B1, 15.0 parts of spherical porous light calcium carbonate (trade name: Cal-Light-KT, particle diameter: 2.6 μm, produced by Shiraishi Calcium Kaisha, Ltd., powder, oil absorption: 120 ml/100 g) was used instead of 50.8 parts of fine silica (trade name: Silojet A30X, average particle diameter: 0.3 μm, produced by Grace Co., solids concentration: 29.5 mass %, oil absorption: 180 ml/100 g).

### Example B5

A heat-sensitive recording material was obtained in the same manner as in Example B1, except that in the preparation of the coating liquid for a light-scattering layer in Example B1, 15.0 parts of light calcium carbonate (trade name; Brilliant-15, particle diameter: 0.6 μm, produced by Shiraishi Calcium Kaisha, Ltd., powder, oil absorption: 56 ml/100 g) was used instead of 50.8 parts of fine silica (trade name: Silojet A30X, average particle diameter: 0.3 μm, produced by Grace Co., solids concentration: 29.5 mass %, oil absorption: 180 ml/100 g).

### Example B6

A heat-sensitive recording material was obtained in the same manner as in Example B1, except that in the preparation of the coating liquid for a light-scattering layer in Example B1, the amount of the fine silica (trade name: Silojet A30X, average particle diameter: 0.3 μm, produced by Grace Co., solids concentration: 29.5 mass %, oil absorption: 180 ml/100 g) was changed from 50.8 parts to 16.9 parts, and 10.0 parts of spherical porous light calcium carbonate (trade name: Cal-Light-KT, particle diameter: 2.6 μm, produced by Shiraishi Calcium Kaisha, Ltd., powder, oil absorption: 120 ml/100 g) was further used.

### Example B7

A heat-sensitive recording material was obtained in the same manner as in Example B1, except that in the preparation of the coating liquid for a light-scattering layer in Example B1, the amount of the fine silica (trade name: Silojet A30X, average particle diameter: 0.3 μm, produced by Grace Co., solids concentration: 29.5 mass %, oil absorption: 180 ml/100 g) was changed from 50.8 parts to 16.9 parts, and the amount of the 10.0% aqueous solution of fully saponified PVA (trade name: Kuraray Poval 11-98, produced by Kuraray Co., Ltd.) was changed from 70.0 parts to 170.0 parts.

### Example B8

A heat-sensitive recording material was obtained in the same manner as in Example B1, except that in the preparation of the coating liquid for a light-scattering layer in Example B1, the amount of the fine silica (trade name: Silojet A30X, average particle diameter: 0.3 μm, produced by Grace Co., solids concentration: 29.5 masse, oil absorption: 180 ml/100 g) was changed from 50.8 parts to 101.7 parts, the amount of the non-hollow polymer particles (trade name: Glossdell 130S, average particle diameter: 0.6 μm, produced by Mitsui Chemicals, Inc., solids concentration: 53.0 mass %) was changed from 9.4 parts to 0 parts, the amount of the 10.08 aqueous solution of fully saponified PVA (trade name: Kuraray Poval 11-98, produced by Kuraray Co., Ltd.) was changed from 70.0 parts to 20.0 parts, and the amount of the aqueous dispersion of zinc stearate (trade name: Hidorin Feb. 9, 1936, produced by Chukyo Yushi Co., Ltd., solids concentration: 36.0%) was changed from 27.8 parts to 13.9 parts.

### Example B9

A heat-sensitive recording material was obtained in the same manner as in Example B1, except that in the preparation of the coating liquid for a light-scattering layer in Example B1, the amount of the plastic hollow particle dispersion (trade name: Ropaque Ultra-E, hollow ratio: 44%, average particle diameter: 0.4 μm, produced by The Dow Chemical Company, solids concentration: 29.5 mass %) was changed from 101.7 parts to 16.9 parts, and the amount of the 10.0% aqueous solution of fully saponified PVA (trade name: Kuraray Poval 11-98, produced by Kuraray Co., Ltd.) was changed from 70.0 parts to 320.0 parts.

### Example B10

A heat-sensitive recording material was obtained in the same manner as in Example B1, except that in the preparation of the coating liquid for a light-scattering layer in Example B1, the amount of the plastic hollow particle dispersion (trade name: Ropaque Ultra-E, hollow ratio: 44%, average particle diameter: 0.4 μm, produced by The Dow Chemical Company, solids concentration: 29.5 mass %) was changed from 101.7 parts to 135.6 parts, the amount of the 10.0% aqueous solution of fully saponified PVA (trade name: Kuraray Poval 11-98, produced by Kuraray Co., Ltd.) was changed from 70.0 parts to 20.0 parts, and the amount of the aqueous dispersion of zinc stearate (trade name: Hidorin Z-9-36, produced by Chukyo Yushi Co., Ltd., solids concentration: 36.0%) was changed from 27.8 parts to 13.9 parts.

### Example B11

A heat-sensitive recording material was obtained in the same manner as in Example B1, except that in the preparation of the coating liquid for a light-scattering layer in Example B1, the amount of the fatty acid amide dispersion obtained in (2) was changed from 120.0 parts to 40.0 parts, and 45.5 parts of the clarifying agent dispersion obtained as in (5) below was further used.

### (5) Preparation of Clarifying Agent Dispersion

44 parts of oxalic acid-di-p-methylbenzyl ester, 44 parts of a 10% aqueous solution of partially saponified PVA (trade name: Kuraray Poval 5-88, produced by Kuraray Co., Ltd.), and 12 parts of water were mixed. The resulting mixture was pulverized with a sand mill (produced by Aimex Co., Ltd.; a sand grinder) to a median diameter measured with a SALD2200 laser diffraction particle diameter distribution analyzer (produced by Shimadzu Corporation) of 1.0 μm, thereby obtaining a clarifying agent dispersion.

### Example B12

A heat-sensitive recording material was obtained in the same manner as in Example B11, except that in the preparation of the clarifying agent dispersion in Example B11, oxalic acid-di-p-chlorobenzyl ester was used instead of oxalic acid-di-p-methylbenzyl ester.

### Example B13

A heat-sensitive recording material was obtained in the same manner as in Example B11, except that in the preparation of the clarifying agent dispersion in Example B11, 1,2-bis(phenoxymethyl)benzene was used instead of oxalic acid-di-p-methylbenzyl ester.

### Example B14

A heat-sensitive recording material was obtained in the same manner as in Example B11, except that in the preparation of the clarifying agent dispersion in Example B11, 1,2-bis(3-methylphenoxy) ethane was used instead of oxalic acid-di-p-methylbenzyl ester.

### Example B15

A heat-sensitive recording material was obtained in the same manner as in Example B11, except that in the preparation of the clarifying agent dispersion in Example B11, diphenyl sulfone was used instead of oxalic acid-di-p-methylbenzyl ester.

### Example B16

A heat-sensitive recording material was obtained in the same manner as in Example B11, except that in the preparation of the coating liquid for a light-scattering layer in Example B11, the amount of the fatty acid amide dispersion obtained in (2) was changed from 40.0 parts to 0 parts, and the amount of the clarifying agent dispersion obtained in (5) was changed from 45.5 parts to 68.2 parts.

### Comparative Example B1

A heat-sensitive recording material was obtained in the same manner as in Example B1, except that in the preparation of the coating liquid for a light-scattering layer in Example B1, the amount of the plastic hollow particle dispersion (trade name: Ropaque Ultra-E, hollow ratio: 44%, average particle diameter: 0.4 μm, produced by The Dow Chemical Company, solids concentration: 29.5 mass %) was changed from 101.7 parts to 0 parts, and the amount of the 10.0% aqueous solution of fully saponified PVA (trade name: Kuraray Poval 11-98, produced by Kuraray Co., Ltd.) was changed from 70.0 parts to 370.0 parts.

### Comparative Example B2

A heat-sensitive recording material was obtained in the same manner as in Example B1, except that in the preparation of the coating liquid for a light-scattering layer in Example B1, the amount of the fine silica (trade name: Silojet A30X, average particle diameter: 0.3 μm, produced by Grace Co., solids concentration: 29.5 mass %, oil absorption: 180 ml/100 g) was changed from 50.8 parts to 0 parts, and the amount of the 10.0% aqueous solution of fully saponified PVA (trade name: Kuraray Poval 11-98, produced by Kuraray Co., Ltd.) was changed from 70.0 parts to 220.0 parts.

### Comparative Example B3

A heat-sensitive recording material was obtained in the same manner as in Example B1, except that in the preparation of the coating liquid for a light-scattering layer in Example B1, the amount of the fatty acid amide dispersion obtained in (2) was changed from 120.0 parts to 0 parts, and the amount of the 10.0% aqueous solution of fully saponified PVA (trade name: Kuraray Poval 11-98, produced by Kuraray Co., Ltd.) was changed from 70.0 parts to 400.0 parts.

The Examples and Comparative Examples above were evaluated according to the following methods. Table 2 shows the results.

### ISO Whiteness

Four sheets of each of the obtained heat-sensitive recording materials were stacked, and the ISO whiteness was measured with an SC-WI color meter (produced by Suga Test Instruments Co., Ltd.). The ISO whiteness is required to be 35 or more, preferably 40 or more, and more preferably 50 or more.

### Print Density

Recording was performed on each heat-sensitive recording material at an applied energy of 0.24 mJ/dot by using a thermal recording tester (trade name: TH-PMD, produced by Ohkura Electric Co., Ltd.). The obtained printed portion was measured with a Macbeth densitometer (RD-914, produced by Macbeth Co., Ltd.) in visual mode. A larger value indicates a higher print density. The recording density is required to be 1.30 or more, and preferably 1.40 or more.

### Printability

Solid black printing (18 cm) was performed 6 times at an applied energy of 5 A by using a thermal printer (trade name: L'esprit T-408v-ex, produced by Sato Corporation), and the amount of head residue adhering to the thermal head was evaluated according to the following criteria.
A: A very small amount of head residue was observed, and there was no problem in practical use.
B: Adhesion of head residue was observed, but there was no problem in practical use.
C: A large amount of head residue was observed, and printing problems occurred before printing was performed 6 times; there was a problem in practical use.

### Thermal Head Abrasion Resistance

A load of 200 g was applied to a brass ball with a diameter of 0.3175 cm, and the brass ball was allowed to run for 125 m on the surface of each of the heat-sensitive recording materials. The abrasion depth on the brass ball was measured with a VHX-S15 profile measurement unit produced by Keyence Corporation, and was evaluated according to the following criteria. The smaller the abrasion depth, the better the head abrasion resistance. The head abrasion resistance is required to be 100 μm or less.
A: Abrasion depth was 60 μm or less,
B: Abrasion depth was more than 60 μm and 100 μm or less.
C: Abrasion depth was more than 100 μm.

TABLE 2

| | Particle | Oil | | | | |
|---|---|---|---|---|---|---|
| | diameter | absorption | Ex. | Ex. | Ex. | Ex. |
| | (μm) | (ml/100 g) | B1 | B2 | B3 | B4 |
| Hollow polymer particles | | | | | | |
| Ropaque Ultra-E | 0.4 | — | 30 | 30 | 30 | 30 |
| Inorganic pigment | | | | | | |
| Silojet A30X | 0.3 | 180 | 15 | | | |
| Nipsil E-743 | 1.5 | 170 | | 15 | | |
| Ansilex 93 | 2.6 | 104 | | | 15 | |
| Cal-Light-KT | 2.3 | 120 | | | | 15 |
| Brilliant-15 | 0.6 | 56 | | | | |
| Clarifying agent | | | | | | |
| Fatty acid amide | — | — | 30 | 30 | 30 | 30 |
| Oxalic acid-di-p-methylbenzyl ester | — | — | | | | |
| Oxalic acid-di-p-chlorobenzyl ester | — | — | | | | |
| 1,2-Di(phenoxymethyl)benzene | — | — | | | | |
| 1,2-Di(3-methylphenoxy)ethane | — | — | | | | |
| Diphenyl sulfone | — | — | | | | |
| Glossdell 130S | — | — | 5 | 5 | 5 | 5 |
| Binder | — | — | 10 | 10 | 10 | 10 |
| Wax | — | — | 10 | 10 | 10 | 10 |
| Total | | | 100 | 100 | 100 | 100 |
| ISO whiteness | | | 50 | 57 | 55 | 54 |
| Print density | | | 1.40 | 1.35 | 1.45 | 1.44 |
| Printability | | | A | A | A | A |
| Thermal head abrasion resistance | | The numbers in | A (20) | B (65) | B (95) | B (81) |
| | | parentheses indicate | | | | |
| | | abrasion depth. | | | | |

| | Ex. | Ex. | Ex. | Ex. | Ex. | Ex. |
|---|---|---|---|---|---|---|
| | B5 | B6 | B7 | B8 | B9 | B10 |
| Hollow polymer particles | | | | | | |
| Ropaque Ultra-E | 30 | 30 | 30 | 30 | 5 | 40 |
| Inorganic pigment | | | | | | |
| Silojet A30X | | 5 | 5 | 30 | 15 | 15 |
| Nipsil E-743 | | | | | | |
| Ansilex 93 | | | | | | |
| Cal-Light-KT | | 10 | | | | |
| Brilliant-15 | 15 | | | | | |
| Clarifying agent | | | | | | |
| Fatty acid amide | 30 | 30 | 30 | 30 | 30 | 30 |
| Oxalic acid-di-p-methylbenzyl ester | | | | | | |
| Oxalic acid-di-p-chlorobenzyl ester | | | | | | |
| 1,2-Di(phenoxymethyl)benzene | | | | | | |
| 1,2-Di(3-methylphenoxy)ethane | | | | | | |
| Diphenyl sulfone | | | | | | |
| Glossdell 130S | 5 | 5 | 5 | | 5 | 5 |
| Binder | 10 | 10 | 20 | 5 | 35 | 5 |
| Wax | 10 | 10 | 10 | 5 | 10 | 5 |
| Total | 100 | 100 | 100 | 100 | 100 | 100 |
| ISO whiteness | 54 | 52 | 48 | 52 | 36 | 61 |
| Print density | 1.44 | 1.43 | 1.43 | 1.32 | 1.50 | 1.31 |
| Printability | B | A | B | A | A | A |
| Thermal head abrasion resistance | A (45) | A (57) | A (17) | A (30) | A (21) | A(18) |

| | Particle | Oil | | |
|---|---|---|---|---|
| | diameter | absorption | Ex. | Ex. |
| | (μm) | (ml/100 g) | B11 | B12 |
| Hollow polymer particles | | | | |
| Ropaque Ultra-E | 0.4 | — | 30 | 30 |
| Inorganic pigment | | | | |
| Silojet A30X | 0.3 | 180 | 15 | 15 |
| Nipsil E-743 | 1.5 | 170 | | |
| Ansilex 93 | 2.6 | 104 | | |
| Cal-Light-KT | 2.3 | 120 | | |
| Brilliant-15 | 0.6 | 56 | | |
| Clarifying agent | | | | |
| Fatty acid amide | — | — | 10 | 10 |
| Oxalic acid-di-p-methylbenzyl ester | — | — | 20 | |
| Oxalic acid-di-p-chlorobenzyl ester | — | — | | 20 |
| 1,2-Di(phenoxymethyl)benzene | — | — | | |
| 1,2-Di(3-methylphenoxy)ethane | — | — | | |
| Diphenyl sulfone | — | — | | |
| Glossdell 130S | — | — | 5 | 5 |
| Binder | — | — | 10 | 10 |
| Wax | — | — | 10 | 10 |
| Total | | | 100 | 100 |
| ISO whiteness | | | 51 | 51 |
| Print density | | | 1.41 | 1.41 |
| Printability | | | A | A |
| Thermal head abrasion resistance | | The numbers in | A(20) | A(20) |
| | | parentheses indicate | | |
| | | abrasion depth. | | |

| | Ex. | Ex. | Ex. | Ex. |
|---|---|---|---|---|
| | B13 | B14 | 815 | B16 |
| Hollow polymer particles | | | | |
| Ropaque Ultra-E | 30 | 30 | 30 | 30 |
| Inorganic pigment | | | | |
| Silojet A30X | 15 | 15 | 15 | 15 |
| Nipsil E-743 | | | | |
| Ansilex 93 | | | | |
| Cal-Light-KT | | | | |
| Brilliant-15 | | | | |
| Clarifying agent | | | | |
| Fatty acid amide | 10 | 10 | 10 | |
| Oxalic acid-di-p-methylbenzyl ester | | | | 30 |
| Oxalic acid-di-p-chlorobenzyl ester | | | | |
| 1,2-Di(phenoxymethyl)benzene | 20 | | | |
| 1,2-Di(3-methylphenoxy)ethane | | 20 | | |
| Diphenyl sulfone | | | 20 | |
| Glossdell 130S | 5 | 5 | 5 | 5 |
| Binder | 10 | 10 | 10 | 10 |
| Wax | 10 | 10 | 10 | 10 |
| Total | 100 | 100 | 100 | 100 |
| ISO whiteness | 51 | 51 | 51 | 52 |
| Print density | 1.41 | 1.41 | 1.41 | 1.42 |
| Printability | A | B | B | B |
| Thermal head abrasion resistance | A(20) | A(20) | A(20) | A(20) |

| | Comp. | Comp. | Comp. |
|---|---|---|---|
| | Ex. | Ex. | Ex. |
| | B1 | B2 | B3 |
| Hollow polymer particles | | | |
| Ropaque Ultra-E | | 30 | 30 |
| Inorganic pigment | | | |
| Silojet A30X | 15 | | 15 |
| Nipsil E-743 | | | |
| Ansilex 93 | | | |
| Cal-Light-KT | | | |
| Brilliant-15 | | | |
| Clarifying agent | | | |
| Fatty acid amide | 30 | 30 | |
| Oxalic acid-di-p-methylbenzyl ester | | | |
| Oxalic acid-di-p-chlorobenzyl ester | | | |
| 1,2-Di(phenoxymethyl)benzene | | | |
| 1,2-Di(3-methylphenoxy)ethane | | | |
| Diphenyl sulfone | | | |
| Glossdell 130S | 5 | 5 | 5 |
| Binder | 40 | 25 | 40 |
| Wax | 10 | 10 | 10 |
| Total | 100 | 100 | 100 |
| ISO whiteness | 31 | 45 | 46 |
| Print density | 1.49 | 1.47 | 0.98 |
| Printability | A | C | A |
| Thermal head abrasion resistance | A(22) | A(15) | A(20) |

1. A heat-sensitive recording material comprising:
a support having at least one colored surface; and
a light-scattering layer on the colored surface,
wherein
the light-scattering layer contains a clarifying agent,
the light-scattering layer is substantially free of a dye precursor and a developer, and
any one of the following requirements (A) and (B) is satisfied:
(A) the light-scattering layer further contains non-hollow polymer particles, the content of the non-hollow polymer particles is 25 to 60 mass % based on the total solids content of the light-scattering layer, and the content of the clarifying agent is 10 to 40 mass % based on the total solids content of the light-scattering layer; and
(B) the light-scattering layer further contains hollow polymer particles and an inorganic pigment.

2. The heat-sensitive recording material according to claim 1, which satisfies the requirement (A).

3. The heat-sensitive recording material according to claim 2, wherein the clarifying agent contains at least one member selected from the group consisting of stearic acid amide, palmitic acid amide, aromatic oxalic acid ester, aromatic ethylene glycol ether, ethylene-bis-stearic acid amide, 1,2-diphenyloxyethane, 1,2-bis(3-methylphenoxy) ethane, dibenzyl oxalate, dibenzyl terephthalate, benzyl-biphenyl, benzyl-2-naphthyl ether, diphenyl sulfone, m-terphenyl, p-benzyloxybenzyl benzoate, cyclohexane dimethanol benzoate, p-toluenesulfonamide, o-toluenesulfonamide, 2,6-diisopropylnaphthalene, 4,4-diisopropylbiphenyl, and erucic acid amide.

4. The heat-sensitive recording material according to claim 2, wherein the clarifying agent contains at least one member selected from the group consisting of stearic acid amide and palmitic acid amide.

5. The heat-sensitive recording material according to claim 2, wherein the clarifying agent contains both stearic acid amide and palmitic acid amide.

6. The heat-sensitive recording material according to claim 2, wherein the content of the non-hollow polymer particles is 30 to 50 mass % based on the total solids content of the light-scattering layer.

7. The heat-sensitive recording material according to claim 2, wherein the content of the clarifying agent is 20 to 35 mass % based on the total solids content of the light-scattering layer.

8. The heat-sensitive recording material according to claim 2, wherein the average particle diameter of the non-hollow polymer particles is 0.2 to 3.0 μm.

9. The heat-sensitive recording material according to claim 2, wherein the refractive index of the non-hollow polymer particles is 1.55 to 1.65.

10. The heat-sensitive recording material according to claim 1, which satisfies the requirement (B).

11. The heat-sensitive recording material according to claim 10, wherein the inorganic pigment comprises an inorganic pigment having an oil absorption of 100 ml/100 g or more.

12. The heat-sensitive recording material according to claim 10, wherein the inorganic pigment comprises an inorganic pigment having an average particle diameter of 0.2 to 0.7 μm.

13. The heat-sensitive recording material according to claim 10, wherein the content of the inorganic pigment is 10 to 25 mass % based on the total solids content of the light-scattering layer.

14. The heat-sensitive recording material according to claim 10, wherein the content of the hollow polymer particles is 6 to 35 mass % based on the total solids content of the light-scattering layer.

15. The heat-sensitive recording material according to claim 10,
wherein the content of the clarifying agent is 1 part by mass or more, on a solids basis, per part by mass of the hollow polymer particles, and
wherein the clarifying agent
A) consists of a fatty acid amide, or
B) comprises a combination of a fatty acid amide and at least one member selected from the group consisting of a compound represented by the following formula (1) and 1,2-bis(phenoxymethyl)benzene; 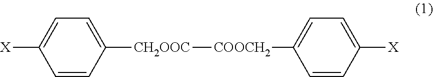
wherein in the formula, Xs are the same or different, and each represents CH₃ or Cl.
